(19) United States
(12) Patent Application Publication
(10) Pub. No.: US 2005/0044140 A1
(43) Pub. Date: Feb. 24, 2005

(54) Information processing method, information processing system, information processing apparatus and computer readable information recording medium

(75) Inventor: Minoru Urabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/790,118

(22) Filed: Mar. 2, 2004

(30) Foreign Application Priority Data
Aug. 21, 2003 (JP) 2003-297638

(51) Int. Cl. G06F 15/16; G06F 12/00

(52) U.S. Cl. 709/203; 711/148

(57) ABSTRACT

A method comprises the steps of: collectively managing respective storage areas registered, which storage areas belong to storage apparatuses of servers connected with a communication network, respectively; allocating a one of the storage areas managed by the managing part, in response to an allocation request made by the server; and mounting the storage area of the storage apparatus allocated in response to a mounting request made by the server, and transmitting mounting information indicating this matter to the server as a response.

### BACKGROUND OF THE INVENTION

1. Field of the Invention

The present invention relates to an information processing method, an information processing system, an information processing apparatus and a computer readable information recording medium, and, in particular, to an information processing method, an information processing system and an information processing apparatus by which storage areas of a plurality of information processing apparatuses connected together via a communication network are shareable thereamong with a relatively simple configuration, and a computer readable information recording medium storing therein a program which causes a computer to execute functions to achieve the information processing apparatus acting a relevant role in the information processing system.

2. Description of the Related Art

A DAS (direct attached storage) is well-known as an example of a storage system. In the DAS, as well-known, a server and a storage apparatus are directly connected. In such a configuration of a DAS, basically, the server accesses only the storage apparatus (disk apparatus or so) belonging thereto, i.e., the storage apparatus directly connected thereto, exclusively. The storage capacity in the storage apparatus in the DAS is determined as a value including some extent of margin in general. Accordingly, the storage area thereof may not always be utilized efficiently, and thus, a considerable part thereof may be left unused.

As another example of a storage system,

SAN (storage area network) is known. In the SAN, as well-known, a plurality of servers and a plurality of storage apparatuses are connected via a communication network, and, basically, the plurality of storage apparatuses are shared by the plurality of servers. Accordingly, the above-mentioned problem concerning the DAS system is solved. That is, the storage areas of the storage apparatuses can be recognized as if they are an integrated virtual storage area in the system, and the virtual storage area may be allocated for the respective servers as the necessity arises. Thus, according to the SAN, as the respective storage apparatuses are independent from the particular servers, the storage areas thereof can be utilized in a free way according to a request given.

### SUMMARY OF THE INVENTION

However, many products of the above-mentioned DAS have been already installed and operated actually, and if such existing systems are changed into the above-mentioned SAN, considerable costs and time may be needed, for example. Furthermore, in the SAN, in order to provide a high speed medium access performance, an allowable length of a cable used as a signal transmission medium is limited in general. Accordingly, in many cases, to change DAS into SAN is not easy in general.

The present invention has been devised in consideration of the above-mentioned problems, and an object of the present invention is to provide a system in which, existing systems of DASs are maintained as they are, while storage areas of information processing apparatuses connected via a communication network can be shared thereamong with a relatively simple configuration.

According to the present invention, a plurality servers (referred to as individual servers hereinafter) register at least part of storage areas of storage apparatuses of their own in a management server connected to a communication network. Then, the management server collectively manages the storage areas of the storage apparatuses of the individual servers thus registered.

One of the individual servers which needs to actually access the storage areas thus registered by the management server may request the management server to allocate a storage area of those of the storage apparatuses managed by the management server. The management server receiving this request allocates a predetermined storage area from among the collectively managed storage areas therefor.

Then, the above-mentioned individual server makes mounting request for the storage area thus allocated therefor to the management server. In response thereto, the management server performs mounting of the allocated storage area of the storage apparatus, and transmits predetermined mounting information indicating this matter and including physical disk information for the allocated storage area, as a response.

The individual server (referred to as the first individual server) which receives this response then requests another one of the individual servers (referred to as the second individual server), to which the relevant storage area thus allocated for the first individual server originally belongs, along a path created by the relevant mounting operation, based on the mounting information in the response. The second individual server receiving this access request accesses the relevant storage area of its own so as to perform predetermined access operation according to the request by the first individual server, and returns a result of this access operation to the first individual server.

The first individual server which has thus completed the access operation in the above-described process then may preferably request the management server to unmount the storage areas once mounted as mentioned above. The management server receiving this unmounting request may preferably unmount the relevant storage area, and returns unmounting information indicating this matter to the first individual server.

With the above-described configuration, each individual server is allowed to access the storage area of another individual server through the mounting step performed via the management server. Accordingly, each individual server is allowed to share the storage areas of the other individual server.

According to the present invention, such a drastic alteration of the system as that otherwise required for changing DAS into SAN is not needed for achieving the above-described configuration. Rather, storage area management like management of a storage pool in which various types of usage ways may be set can be achieved merely with management of mounting information via the management server which is provided in the communication network.

### BRIEF DESCRIPTION OF THE DRAWINGS

FIG. 1A shows a block diagram illustrating a general configuration of an information processing system in one embodiment of the present invention;

FIG. 1B shows an example of the contents of a virtual disk management table managed by a management server shown in FIG. 1A;

FIGS. 2A and 2B illustrate an operation in the configuration illustrated in FIGS. 1A and 1B of lending a storage area A2 belonging to a server A and managed by a management server as a virtual disk, to a server J;

FIG. 3 shows a block diagram illustrating a processing procedure of a virtual disk lending operation illustrated in FIGS. 2A and 2B in the embodiment illustrated in FIGS. 1A and 1B; and

FIGS. 4, 5A and 5B, and 6A through 6D illustrate the above-mentioned virtual disk lending operation for each part individually.

### DETAILED DESCRIPTION OF THE PREFERRED EMBODIMENT

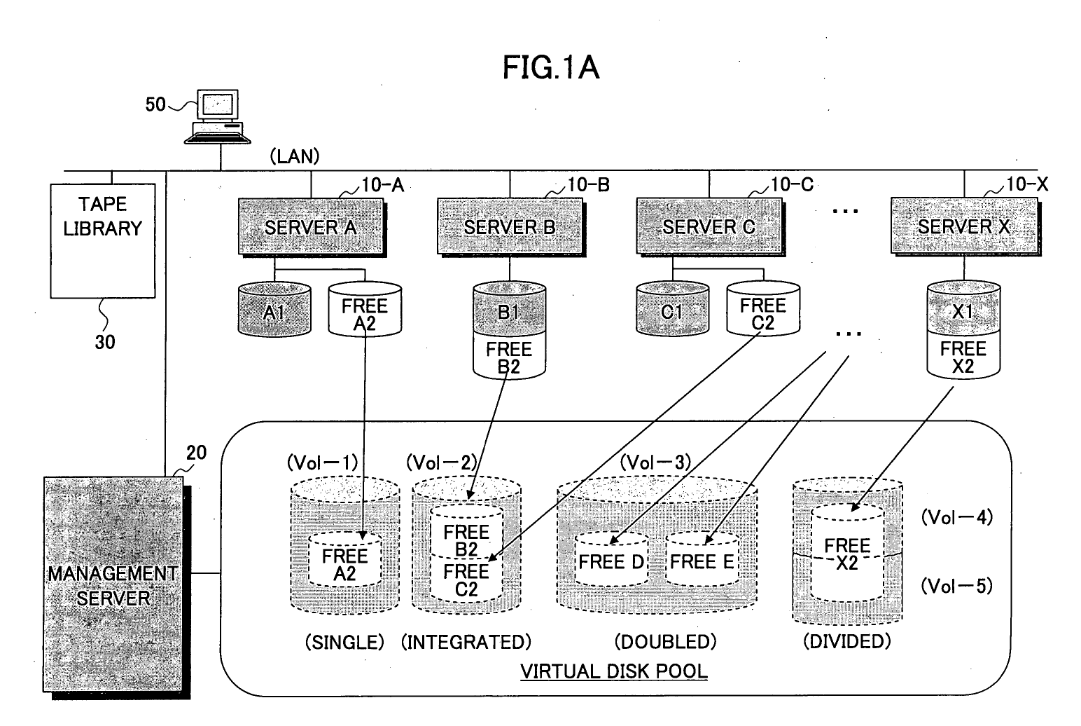

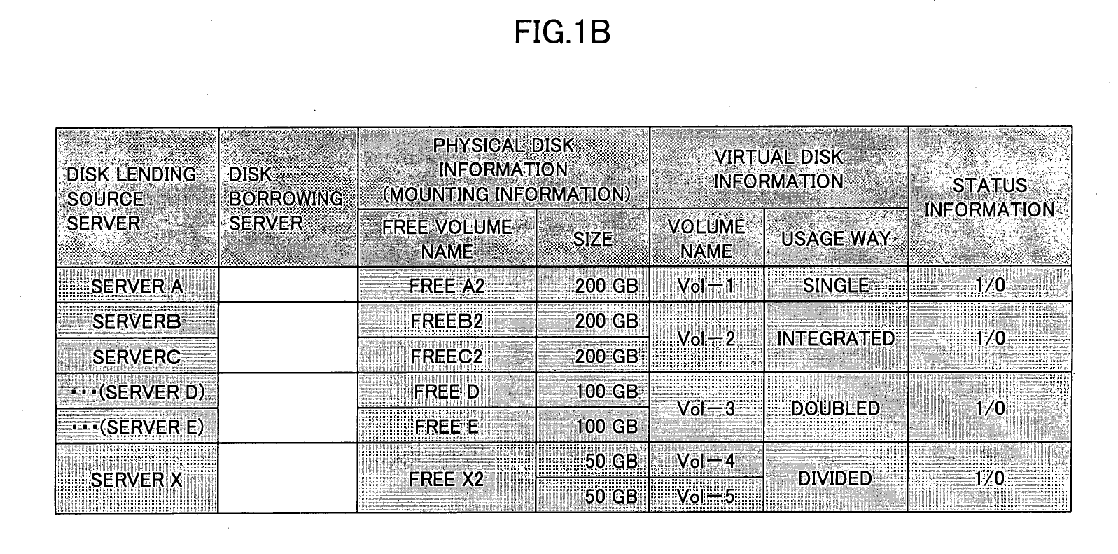

FIG. 1A shows a block diagram illustrating a general configuration of an information processing system in one embodiment of the present invention. The information processing system has a configuration in which a plurality of DASs (direct attached storages) are connected via a communication network (LAN). The respective DASs include respective servers 10-A, 10-B, 10-C, . . . , and 10-X. To these servers, storage apparatuses having storage capacities A1, A2, B1, B2, C1, C2, . . . , X1 and X2, respectively, as shown, are directly connected, respectively. In other words, each server forms a DAS which may have a well-known configuration of a common DAS as a basic configuration thereof (special requirements needed for achieving the present invention will be described later), together with a disk apparatus directly connected to the server.

Each disk apparatus mentioned above may have a well-known configuration of a hard disk drive (HDD) or so, and is directly managed by the relevant server, to which the disk apparatus belongs. Thus, the server A (10-A) has storage areas A1 and A2, the server B (10-B) has storage areas B1 and B2, the server C (10-C) has a storage areas C1 and C2, the server X (10-X) has storage areas X1 and X2, provided by the respective storage apparatuses of their own.

The information processing system described above also has a management server 20 also connected with the respective servers mentioned above via the communication network (LAN). The management server 20 has a virtual disk management table having the contents such as those illustrated in FIG. 1B in a storage apparatus of its own. This virtual disk management table is used to collectively register therein predetermined storage areas from among the above-mentioned storage areas directly managed by the respective servers 10-A through 10-X mentioned above, respectively. The management server 20 collectively manages these storage areas thus registered in the virtual disk management table, and as a result, the above-mentioned respective servers are allowed to share these storage areas thus collectively managed there.

For example, as to the server A (10-A), the storage area A2 of those A1 and A2 of its own is registered in the above-mentioned virtual disk management table of the management server 20, as shown. In this case, as shown in FIGS. 1A and 1B, the storage area A2 is managed as a virtual disk volume named ‘Vol-1’, and as a ‘usage way’ thereof, ‘single’ usage way is applied. Such a ‘usage way’ may be arbitrarily and individually set via the management server 20 by a system manager (person) of the information processing system, for example. The ‘single’ usage way means that this volume Vol-1 is set as a storage area in a manner such that it can be lent simply as a single storage area.

As to the server B (10-B), the storage area B2 of those B1 and B2 belonging to this server B is registered as a virtual disk in the virtual disk management table. However, in this case, as shown in FIGS. 1A and 1B, an ‘integrated’ usage way is applied together with the storage capacity C2 of the other server C (10-C). That is, in this case, the respective storage areas B2 and C2 of these servers B and C are integrated so as to form a single virtual disk volume Vol-2. Accordingly, the physically separate two storage areas B2 and C2 are logically integrated, and finally, can be recognized as the single storage area logically. As a result, when this usage way is applied, it becomes possible to store and manage collectively a single large size of information therein without dividing it.

Furthermore, storage areas D and E belonging to servers D and E (not shown) also connected with the above-mentioned servers A, B, C and so forth via the above-mentioned communication network LAN are similarly registered as a virtual volume Vol-3, as shown. In this case, for these storage areas D and E, a ‘doubled’ usage way is applied. That is, information having the same contents is stored in each of these storage areas D and E in a duplicate manner (the original and a copy, for example). By applying this usage way of storage areas, even if the DAS actually providing the storage area D, for example has a trouble and thus the stored information thereof is destroyed, since the same information (copy) is also stored in the storage area E in the duplicate manner as mentioned above, actual loss of the information can be avoided positively.

As to the storage area X2 belonging to the server X shown, a ‘divided’ usage way is applied. That is, the physical storage area X2 is logically divided into two virtual disk volumes Vol-4 and Vol-5, which are then managed in the divided condition.

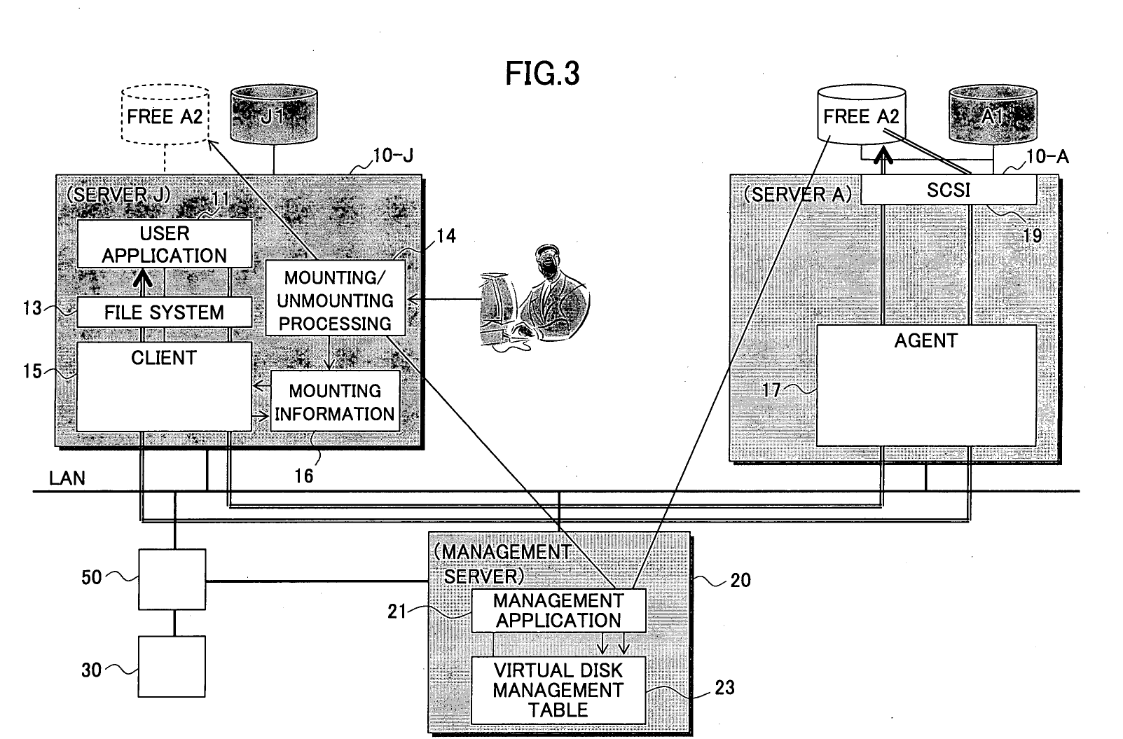

Thereby, these virtual storage areas Vol-4 and Vol-5 may be lent to different servers individually. As a result, it becomes possible to effectively utilize the limited storage capacity. Setting and managing of these usage ways for the storage areas registered in the management server 20 may be achieved in any manner as a result of the above-mentioned virtual disk management table 23 being managed appropriately via a management application program 21 installed in the management server 20, as shown in FIG. 3.

By applying the information processing system in the embodiment of the present invention described above, as shown in FIG. 1A, the respective servers 10-A, 10-B, 10-C, . . . , 10-X included in this system can share the storage areas A2, B2, C2, D, E, . . . , X2 of the other servers as the virtual disk volumes Vol-1, Vol-2, Vol-3 . . . . Furthermore, in this case, a suitable usage way (‘single’, ‘integrated’, ‘doubled’, ‘divided’, or so) may be applied depending on a particular usage situation to apply this system, and thus, efficient utilization of the information storage resources can be achieved in any of various situations applied.

In the information processing system in the embodiment of the present invention described above, each of the servers 10-A, 10-B, 10-C, . . . , and 10-X registers a surplus storage area of its own which may be a part of the entire storage capacity of its own and is not expected to be used at least at the present situation by its own, in the virtual disk management table 23 via the management server 20.

As a manner of registering the storage area in this case, it is possible to register, for each physical sheet of information recording disk as a unit, or, it is also possible to logically divide one physical sheet of disk, and then, to register only a division thereof. Alternatively, it is also possible to register a plurality of sheets of disks which belong to the server together as a single storage area having a large size in a logical manner. In other words, it is possible to achieve registration in any manner depending on how address conversion or so applied is defined for actually utilizing the physical storage area(s) which the server has, as a logical storage area(s).

The same manner may be applied also for the above-mentioned ‘usage way’ of the virtual disk volumes. That is, by performing address conversion or so with a relevant definition therefor again for the storage areas thus registered by the respective servers as mentioned above, it is possible to reconfigure the given storage areas into another logical configuration of storage areas. As a result, it is possible to set any manner of usage ways flexibly.

Then, when the DAS server included in the above-mentioned information processing system needs an extra storage area for some reason, this DAS server can borrow the storage area registered in the virtual disk management table 23 via the management application 21 of the management server 20. Thus, it is possible to achieve effective utilization of a surplus storage area of one DAS which registers it while it is possible for another DAS which needs an extra storage area to avoid generation of extra costs otherwise needed for newly extending for another storage area belonging thereto for the purpose of fulfilling the extra storage area demanded.

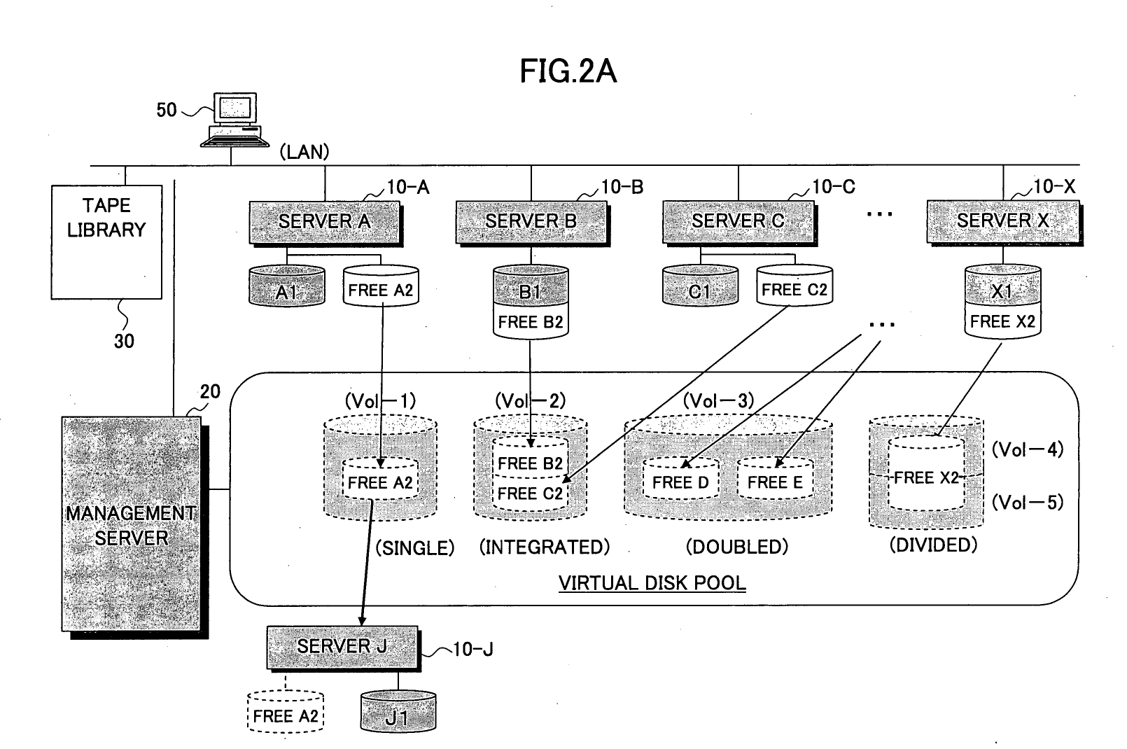

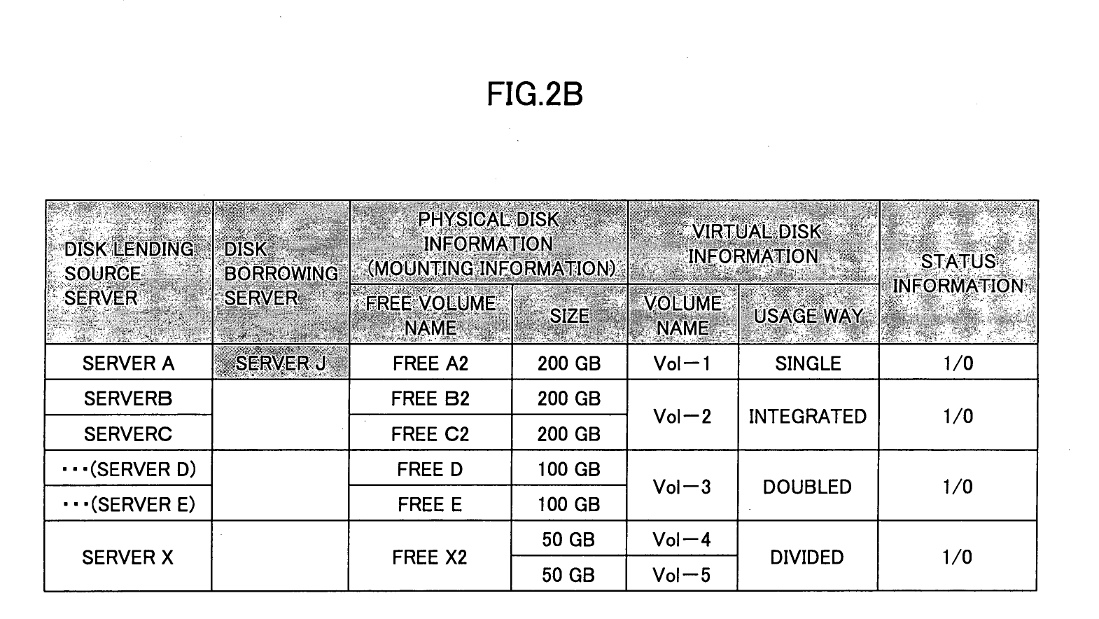

FIGS. 2A and 2B illustrate an example in which a DAS server J (10-J) also included in the information processing system borrows the storage area A2 originally belonging to the server A and registered in the virtual disk management table as the virtual disk volume Vol-1 as mentioned above. In this case, the server J does not need to perform actual extension of the own storage area belonging to its own but can utilize the storage area A2 belonging to the server A to fulfill the storage area newly needed.

As shown in FIG. 1A, the system manager monitors the system via a management terminal 50 also connected to the system via the communication network (LAN) actually, and performs monitoring operation with the management server 20. A storage apparatus 30 such as a tape library or so is further provided separately in the network system, and therewith, for the respective storage areas managed in the virtual disk management table by the management server 20, the storage apparatus 30 may perform backup operation. As a result, it is not necessary for each DAS server which directly manages the respective one of the storage areas to perform backup operation therefor, and thus, it is possible to reduce a processing load and an information storage load to be borne by each DAS server.

In the information processing system in the embodiment of the present invention described above, it is not possible to share each of the above-mentioned virtual disk volumes Vol-1, Vol-2, . . . alone. In other words, for example, the virtual storage area, i.e., the logical disk Vol-1 can be lent to a specific server, for example, the server J. However, it is not possible that this single virtual disk Vol-1 is lent to both two servers J and K and is shared therebetween at a time.

With reference FIGS. 3, 4, 5A, 5B, 6A, 6B, 6C and 6D, processing which enables sharing of the storage areas belonging to the above-mentioned respective servers in the information processing system in which the plurality of DASs are connected via the communication network according to the embodiment of the present invention will now be described in detail.

As shown in FIG. 3, the server of each DAS has an application program 11 which is directly used by a user, a file system program 13 for managing storage of information, a client program 15 for requesting access to an external storage area in response to an instruction given by the file system program 13 or so, a mounting/unmounting processing program 14. (will be described later) and an agent program 17 executing processing requested externally. Furthermore, the management server 20 includes the above-mentioned virtual disk management table 23, and the management application program 21 for collectively managing the storage areas individually registered by the respective DAS servers based on the information stored in the virtual disk management table 23.

In FIG. 3, as parts/components of the respective server A (10-A), the server J (10-J) and the management server 20, only those directly relating to specific processing of borrowing the storage area A2 of the server A by the server J described above with reference to FIGS. 2A and 2B are shown. Further, actually, as mentioned above, the system manager operates the management server 20 via the management terminal 50 and performs status monitoring operation. However, illustration will be made as if the system manager directly operates the management server 20, for the purpose of simplification of the description.

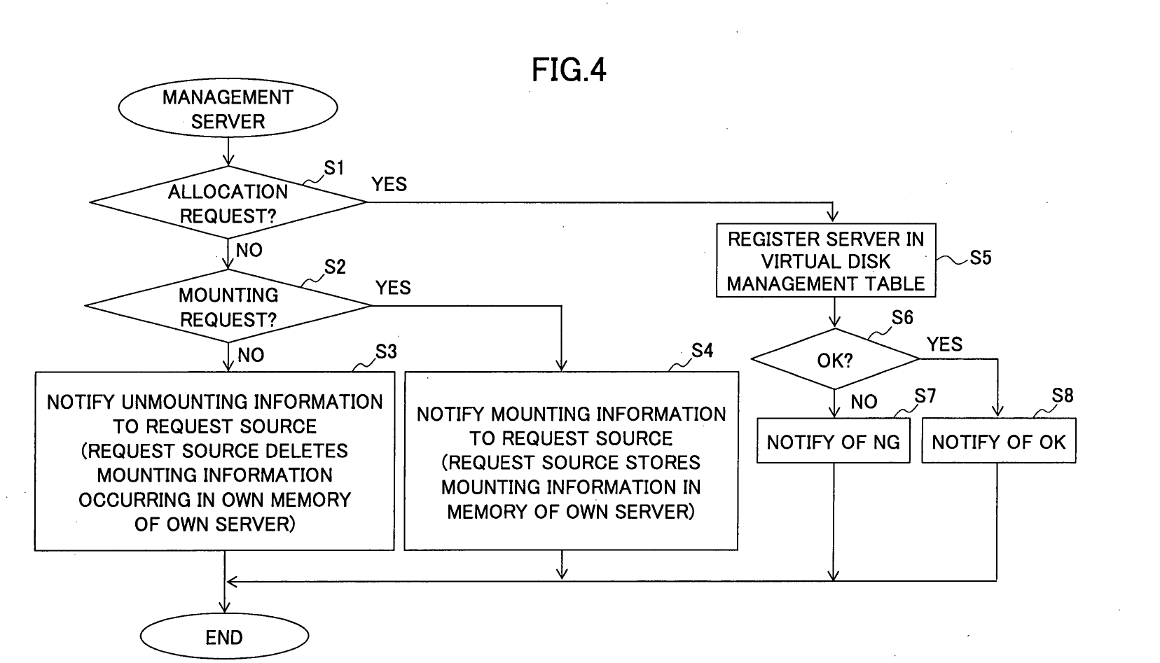

First, the file system program 13 of the server J (10-J) requests an extra storage area via the management server 20 with the client program 15 in response to an instruction input by an operator, for example. The management server 20, receiving this request (Yes in Step S1 in FIG. 4), allocates the free virtual disk Vol-1 (A2) from the virtual disk management table 23, for the server J, through a predetermined storage area allocation procedure (in Step S5). Then, the management server 20 returns an OK notification in Step S8. Simultaneously, the management application program 21 in the management server 20 registers the server J at a place of ‘borrow server’ for Vol-1 in the virtual disk management table 23 (see FIG. 2B).

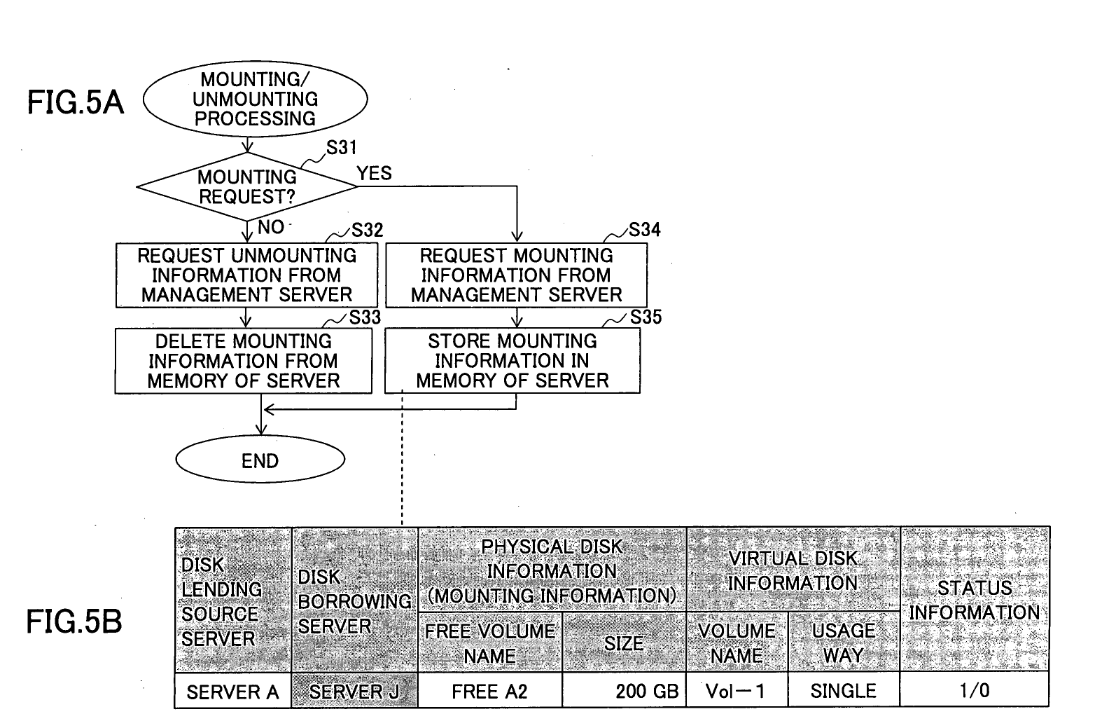

The operator of the server J then requests the management server 20 to mount the relevant virtual disk Vol-1 through the above-mentioned mounting/unmounting processing program 14 (Yes in Step 31 and Step S34 in FIG. 5A). The management application 21 in the management server 20, receiving this request (Yes in Step S2 and Step S4), mounts the relevant storage area A2 of the server A for the server J (10-J), and returns mounting information indicating this matter to the server J which is the request source.

The mounting/unmounting processing program 14 of the server J receiving this response stores the returned mounting information 16 in Step S35 in FIG. 5A. This mounting information includes the contents shown in FIG. 5B, for example. That is, the mounting information includes information included in the virtual disk management table 23 especially the part concerning the relevant storage area A2 thus allocated, and, at the place of ‘status information’ in this table, “1” is set which means the actually mounted state.

After that, through the user application program 11 in the server J, actual access to the thus-allocated virtual disk Vol-1, i.e., the storage area A2 of the server A is performed along a path created by the above-mentioned mounting operation. That is, the client program 15 receiving the access request from the user application program 11 in the server J refers to the mounting information 16 obtained through the mounting/unmounting processing program in Step S35 mentioned above and stored, i.e., the contents shown in FIG. 5B, and then requests the agent program 17 of the relevant server A to access the storage area A2, with a use of the communication path thus created in the above-mentioned mounting operation, in Step S51.

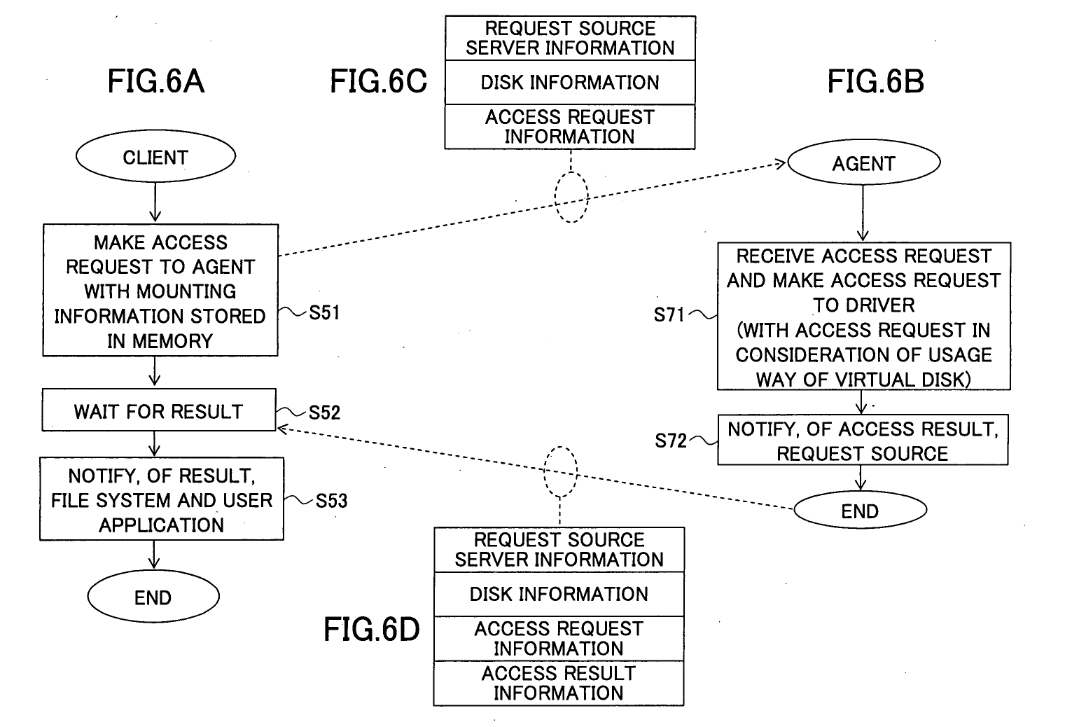

At this time, the information transmitted to the agent program 17 in the server A from the client program in the server J based on the above-mentioned mounting information 16 includes, as shown in FIG. 6C, request-source server information (indicating the server J of its own), disk information (indicating the storage area A2 to which access is made) and access request information (indicating the specific contents of access operation to request).

Receiving this request, the agent program 17 in the server A requests the driver program 19 of its own which directly manages the storage areas of its own, to access the storage area A2 (Step S71 in FIG. 6B). At this time, the agent program 17 achieves this access in a predetermined manner according to the relevant usage way (‘single’ is set in this case as shown in FIG. 5B) previously registered for the relevant storage area A2 in the virtual disk management table 23 by referring to the registered information in this table 23.

The above-mentioned access operation performed through the agent program 17 and the driver program 19 in the server A for the storage area A2 may include, for example, initialization of the relevant storage area, actual writing of information to be stored there, reading of stored information, searching the storage area, re-writing or so. After the necessary access operation has been thus completed, the agent program 17 in the server A returns the result thereof in Step S72.

The information thus returned to the client program 15 in the server J from the agent program 17 in the server A includes, as shown in FIG. 6D, the request-source server information, the disk information and the access request information shown in FIG. 6C together with access result information indicating the above-mentioned access result.

Receiving the access result information (Step S52 in FIG. 6A), the client program in the server J notifies of this information the user application program 11 via the file system program 13, in Step S53, shown in FIG. 6A. Then, the operator of the server J inputs an instruction to the server J for unmounting the relevant storage area A2 for which the necessary access operation has been completed as mentioned above. Receiving this request, the mounting/unmounting processing program 14 in the server J shown in FIG. 3 requests the management server 20 to unmount the relevant storage area A2 (No in Step S31 and Step S32 in FIG. 5A).

Receiving this request (No in Step S1 and No in Step S2 in FIG. 4), the management server 20 performs a predetermined operation for unmounting the storage area A2 of the server A from the server J, and notifies the request source server J of this result in Step S3. The mounting/unmounting processing program 14 receives this notification and deletes the relevant mounting information once stored in Step S35 as mentioned above, in Step S33.

By the above-mentioned unmounting operation performed by the management server 20, the communication path once created by the above-mentioned mounting operation is released (or disconnected), and as a result, the relevant status information for the virtual disk volume Vol-1 in the virtual disk management table 23 shown in FIG. 2B is reset into “0”. Thus, change in the actual mounted/unmounted state for each virtual disk volume is reflected by the virtual disk management table 23 managed by the management server 20 as the status information therein at each time in a real-time manner.

Thus, according to the embodiment of the present invention, the management server 20 collectively manages the storage areas individually registered by the respective DASs, and then, lends them for DASs which need extra storage areas, under the control of the management server 20. Extra configuration parts needed to be provided in each DAS in order to achieve the configuration according to the present invention are merely the client program 15 requesting access externally, the agent program 17 externally receiving an access request and performing access to its own storage apparatus, and the mounting/unmounting processing program 14 requesting the management server 20 to mount or unmount a predetermined storage area.

The management server 20 should have functions of performing intermediary processing between the server which borrows an extra storage area and the other server which lends the storage area, allocating the storage area to lend, and providing predetermined communication information (mounting information) needed for enabling access to the thus-allocated storage area to the borrowing server, so as to enable access to the lending serer from the borrowing server.

Accordingly, it is possible to provide a system by which storage areas belonging to respective DASs are shareable between the respective DASS.

Furthermore, according to the embodiment of the present invention, a communication path between a first DAS server which needs an extra storage capacity and a second DAS server which has an extra storage capacity which is then allocated for the first DAS server is created by the mounting operation only when an actual access operation is performed, and is then disconnected after the relevant access operation is completed. Accordingly, it is possible to effectively reduce the traffic in the communication network (LAN) connecting these DAS servers together. As a result, it is possible to effectively utilize or operate the signal transmission resources.

The functions executed by each of the above-mentioned borrowing server such as the server J, the lending server such as the server A and the management server 20 described above with reference to FIGS. 3, 4, 5A, 5B and 6A through 6D may be achieved by installing respective software programs in respective computers which act as these respective servers. Each computer thus has the relevant software programs installed therein executes instructions included in the programs with its own CPU as in a well-known general-purpose computer's task processing manner, and thus, performs the respective operations so as to execute the necessary functions. These software pogroms may be installed in these respective computers through predetermined computer-readable information recording media, such as CD-ROMs, or so, from which the CPUs thereof read out the programs, and install them into their own hard disk devices or so. After that, the CPUs read out the instructions therefrom, and execute them in cooperation with other auxiliary devices such as RAMs, ROMs, and so forth. It is also possible that these necessary software programs may be downloaded to these computers via a predetermined communication network such as a backbone network, i.e., the Internet, or any other local network, instead of utilization of the above-mentioned computer readable information recording media such as CD-ROMs.

The present invention is not limited to the above-described embodiment, and variations and modifications may be made without departing from the claimed scope of the present invention.

The present application is based on

Japanese priority application No. 2003-297638, filed on Aug. 21, 2003, the entire contents of which are hereby incorporated by reference.

1. An information processing method for sharing storage areas of respective storage apparatuses of a plurality of servers connected to a communication network thereamong, comprising the steps of:
a) registering the storage areas of the respective storage apparatus of the plurality of servers in a management server;
b) managing collectively in said management server the respective storage areas of the storage apparatuses of the respective servers thus registered;
c) requesting allocation of the storage area of the storage apparatus thus managed;
d) the management server allocating a predetermined one of the storage areas of the storage apparatuses collectively managed in response to the allocation request;
e) requesting the management server to mount the storage area of the storage apparatus thus allocated;
f) the management server mounting the storage area of the storage apparatus allocated in said step d) in response to the mounting request, and transmitting mounting information which indicates this matter as a response;
g) requesting the server, to which said storage area thus mounted belongs, to access said storage area, according to said mounting information thus transmitted; and
h) said server which thus receives the access request accessing the storage area of its own, and transmitting an accessing result as a response.

2. The information processing method as claimed in claim 1, further comprising the steps of:
i) requesting said management server to unmount the storage area once mounted in said step f); and
j) said management server unmounting said storage area in response to the unmounting request made in said step i).

3. The information processing method as claimed in claim 1, wherein:
different storage area usage ways are applicable in the collective management of the registered storage areas of the storage apparatuses in said management server.

4. The information processing method as claimed in claim 3, wherein:
said different storage area usage ways comprise at least one of a single usage way, an integrated usage way, a multiplicate usage way and a divided usage way.

5. The information processing method as claimed in claim 1, wherein:
the collective management of the registered storage areas of the storage apparatuses in said management server is performed in said step b) in such a manner that the storage areas are managed as virtual storage areas logically.

6. The information processing method as claimed in claim 1, wherein:
the accessing operation in said step h) comprises at least an initialization operation, information writing operation, information reading operation, an information searching operation and an information deleting operation.

7. The information processing method as claimed in claim 1, wherein:
said plurality of servers and respective storage apparatuses comprise direct attached storages respectively.

8. An information processing system for sharing storage areas of respective storage apparatuses of a plurality of servers connected to a communication network thereamong, comprising:
a registering part registering the storage areas of the respective storage apparatus of the plurality of servers in a management server;
a managing part managing collectively in said management server the respective storage areas of the storage apparatuses of the respective servers thus registered;
an allocation requesting part requesting allocation of the storage area of the storage apparatus thus managed;
an allocating part in the management server allocating a predetermined one of the storage areas of the storage apparatuses collectively managed, in response to the allocation request;
a mounting requesting part requesting the management server to mount the storage area of the storage apparatus thus allocated;
a mounting part in the management server mounting the storage area of the storage apparatus allocated in said step d) in response to the mounting request, and transmitting mounting information which indicates this matter as a response;
an access requesting part requesting the server, to which said storage area thus mounted originally belongs, to access said storage area of its own, according to said mounting information thus transmitted; and
an accessing part in said server which thus receives the access request accessing the storage area of its own, and transmitting a result of the access as a response.

9. The information processing system as claimed in claim 8, further comprising:
an unmounting requesting part requesting said management server to unmount of the storage area once mounted by said mounting part; and
an unmounting part in said management server unmounting said storage area in response to the unmounting request made by said unmounting requesting part.

10. The information processing system as claimed in claim 8, wherein:
different storage area usage ways are applicable in the collective management of the registered storage areas of the storage apparatuses performed by said managing part of said management server.

11. The information processing system as claimed in claim 10, wherein:
the different storage area usage ways applicable in the collective management of the registered storage areas of the storage apparatuses performed by said managing part of said management server comprise at least one of a single usage way, an integrated usage way, a multiplicate usage way and a divided usage way.

12. The information processing system as claimed in claim 8, wherein:
the collective management of the registered storage areas of the storage apparatuses performed by said managing part of the management server is performed in such a manner that the storage areas are managed as virtual storage areas logically.

13. The information processing system as claimed in claim 8, wherein:
the accessing operation performed by said accessing part comprises at least an initialization operation, an information writing operation, an information reading operation, an information searching operation and an information deleting operation.

14. The information processing system as claimed in claim 8, wherein:
said plurality of servers and the respective storage apparatuses comprise direct attached storages respectively.

15. An information processing apparatus comprising:
a registering part registering a storage area of its own in a management server connected with a communication network;
an allocation requesting part requesting said management server to allocate a storage area managed by said management server; and
a mounting requesting part requesting said management server to mount the storage area of the storage apparatus which has been allocated in response to the allocation request;
an access requesting part requesting, according to mounting information returned from the management server in response to the mounting request, another information processing apparatus which has said storage area mounted by said management server in response to said mounting request, to access said storage area.

16. The information processing apparatus as claimed in claim 15, further comprising an unmounting requesting part requesting said management server to unmount of the storage area once mounted by said management server according to the mounting request.

17. The information processing apparatus as claimed in claim 15, wherein:
an access operation requested by said access requesting part comprises at least an initialization operation, an information writing operation, an information reading operation, an information searching operation and an information deleting operation.

18. The information processing apparatus as claimed in claim 15, comprising a direct attached storage with its own storage apparatus.

19. An information processing apparatus comprising:
a managing part collectively managing storage areas registered, which storage areas belong to storage apparatuses of a plurality of information processing apparatuses connected with a communication network, respectively;
an allocating part allocating a predetermined one of the storage areas collectively managed by said managing part, in response to an allocation request made by a first information processing apparatus of the plurality of information processing apparatuses; and
a mounting part mounting the storage area of the storage apparatus of a second information processing apparatus of the plurality of information processing apparatuses allocated in response to a mounting request made by said first information processing apparatus, and transmitting mounting information indicating this matter to said first information processing apparatus as a response.

20. The information processing apparatus as claimed in claim 19, further comprising:
an unmounting part unmounting, in response to an unmounting request given by the first information processing apparatus, the storage area of the second information processing apparatus once mounted by said mounting part.

21. The information processing apparatus as claimed in claim 19, wherein:
different storage area usage ways are applicable in the collective management of the registered storage areas of the storage apparatuses performed by said managing part.

22. The information processing apparatus as claimed in claim 21, wherein:
the different storage area usage ways applicable in the collective management of the registered storage areas of the storage apparatuses performed by said managing part comprise at least one of a single usage way, an integrated usage way, a multiplicate usage way and a divided usage way.

23. The information processing apparatus as claimed in claim 19, wherein:
the collective management of the registered storage areas of the storage apparatuses performed by said managing part is performed in such a manner that the storage areas are managed as virtual storage areas logically.

24. A computer readable information recording medium storing therein a program causing a computer to execute the following steps of:
a) registering a storage area of its own storage apparatus in a management server connected with a communication network;
b) requesting said management server to allocate a storage area managed by said management server; and
c) requesting said management server to mount the storage area of the storage apparatus which has been allocated in response to the allocation request;
d) requesting, according to mounting information returned from the management server in response to the mounting request, another information processing apparatus which has said storage area mounted by said management server in response to said mounting request, to access said storage area.

25. The computer readable information recording medium as claimed in claim 24, wherein said program further causes the computer to execute the step of:
e) requesting said management server to unmount of the storage area once mounted by said management server according to the mounting request.

26. The computer readable information recording medium as claimed in claim 24, wherein:
an access operation requested in said d) comprises at least an initialization operation, an information writing operation, an information reading operation, an information searching operation and an information deleting operation.

27. The computer readable information recording medium as claimed in claim 24, wherein:
said computer and the storage apparatus thereof comprise a direct attached storage.

28. A computer readable information recording medium storing therein a program causing a computer to execute the steps of:
a) collectively managing respective storage areas registered, which storage areas belong to storage apparatuses of a plurality of information processing apparatuses connected with a communication network, respectively;
b) allocating a predetermined one of the storage areas collectively managed in said step a), in response to an allocation request made by a first information processing apparatus of the plurality of information processing apparatuses connected with the communication network; and
c) mounting the storage area of the storage apparatus of a second information processing apparatus of the plurality of information processing apparatuses allocated in response to a mounting request made by the first information processing apparatus, and transmitting mounting information indicating this matter to said first information processing apparatus as a response.

29. The computer readable information recording medium as claimed in claim 28, wherein said program further causes the computer to execute the step of:
d) unmounting, in response to an unmounting request given by the first information processing apparatus, the storage area of the second information processing apparatus once mounted in said step c).

30. The computer readable information recording medium as claimed in claim 28, wherein:
different storage area usage ways are applicable in the collective management of the registered storage areas of the storage apparatuses performed in said step a).

31. The computer readable information recording medium as claimed in claim 30, wherein:
said different storage area usage ways applicable in the collective management of the registered storage areas of the storage apparatuses performed in said step a) comprise at least one of a single usage way, an integrated usage way, a multiplicate usage way and a divided usage way.

32. The computer readable information recording medium as claimed in claim 28, wherein:
the collective management of the registered storage areas of the storage apparatuses performed in said step a) is performed in such a manner that the storage areas are managed as virtual storage areas logically.
